(19) United States
(12) Patent Application Publication
(10) Pub. No.: US 2002/0113876 A1
(43) Pub. Date: Aug. 22, 2002

(54) Vehicle surveillance system

(76) Inventor: Ki-Sun Kim, Seoul (KR)

Correspondence Address: Robert E. Bushnell, Suite 300, 1522 K Street, N.W., Washington, DC, 20005, US

(21) Appl. No.: 10/073,153

(22) Filed: Feb. 13, 2002

(30) Foreign Application Priority Data
Feb. 16, 2001 (KR) 7677/2001
Jul. 18, 2001 (KR) 43068/2001

(51) Int. Cl. H04N 7/18

(52) U.S. Cl. 348/148; 340/937

(57) ABSTRACT

A vehicle surveillance system comprising a plurality of digital cameras mounted on a vehicles's interior and exterior for photographing the dashboard, the interior environment of the vehicle and exterior views around the vehicle to eliminate blind spots inherent to the vehicle's mirrors. A monitor mounted on a front panel of the vehicle displays photographed images. A removable image memory saves the photographed image information. A sound memory stores a plurality of predetermined sounds, including voice sounds, a sound detector detects sounds in close proximity to the vehicle, a sound analyzer compares a detected sound to the sounds stored in the sound memory; and an alarm generator generates an audible alarm through a speaker to the exterior of the vehicle when the sound analyzer determines the detected sound corresponds to one of the stored sounds.

This application makes reference to, incorporates the same herein, and claims all benefits accruing under 35 U.S.C § 119 from an application entitled Device For Recording Video Of A Car earlier filed in the Korean Industrial Property Office on Feb. 16, 2001, and there duly assigned Serial No. 2001-7677 by that Office and an application entitled Device For Sensing Voice Of A Car earlier filed in the Korean Industrial Property Office on Jul. 18, 2001, and there duly assigned Serial No. 2001-43068 by that Office.

### BACKGROUND OF THE INVENTION

1. Field of the Invention

The present invention relates to a vehicle surveillance system that enables a driver to perceive the outer and inner situation of the vehicle while driving. In particular, the vehicle surveillance system of present invention utilizes an image recorder and a sound analyzer in the vehicle which assists a driver (or a passenger on the front seat) to see, through a monitor mounted in the dashboard, the outside views of all direction that are photographed by a minicam mounted on the exterior of the vehicle (i.e., on the side mirrors), to see, through the monitor, interior images of the vehicle that are also photographed by a minicam mounted at the interior of the vehicle (i.e., on the ceiling of the internal panel), and monitoring various sounds in and/or around the vehicle.

Accordingly, the driver is made more alert to his/her surroundings in order to prevent, or at least take proper action against, damage to the vehicle or theft of the vehicle using the information from the vehicle surveillance system by outputting a designated alarm based on the detection result.

2. Description of the Related Art

In general, vehicles have interior and exterior mirrors for the drivers to be able to look at the vehicles surroundings, and internal speakers to enable the driver to listen to sounds output from installed audio equipment.

A problem with the interior mirrors and the exterior mirrors is that they have blind spots, i.e. areas within and outside the vehicle that the drivers cannot see, according to the angles of the mirrors with respect to the drivers view point. Hence, if the drivers are not careful enough, they often find themselves in danger of damaging the vehicle, such as in minor or serious traffic accidents, or striking a pedestrian.

For example, when the driver tries to maneuver the vehicle backwards in a parking lot utilizing only the interior and exterior mirrors, an object or a pedestrian in the blind spot of each mirror may not be seen and thus would be struck by the vehicle. Also, if the volume to the audio equipment is too loud, a warning shout from the pedestrian or bystander may not be heard.

In addition, although a great number of drivers have one or another kind of alarm systems installed to their cars to protect the cars from any damage or theft, such alarms often mistakenly make sounds regardless of the vehicles surroundings, which causes very disturbing noises to the neighbors.

### SUMMARY OF THE INVENTION

From the foregoing, it may be appreciated that a need has arisen for a new solution for overcoming the problems described above with the traditional vehicle.

It is, therefore, an object of the present invention to provide a vehicle surveillance system having an image recorder and a sound analyzer for a vehicle that enables the driver to see areas in and around the vehicle that can not be seen using only the interior and exterior mirrors and that monitors various sounds near the vehicle.

It is another object of the present invention to mount minicams both on the outside and the inside of the vehicle to photograph and to perform mutual supervision of the vehicle's surroundings, thereby enabling a driver to check the inside and outside areas of the vehicle to prevent damage or theft of the vehicle.

In order to attain the foregoing object, means for saving the images and sounds around the vehicle, means for displaying the images photographed by the minicams, and means for providing sound analysis for analyzing various sounds, including voice information, are mounted within the vehicle. Additionally, a designated alarm is output based on a detection result.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram showing a vehicle a vehicle surveillance system utilizing an image recorder according to a first embodiment of the present invention;

FIG. 2 is a magnified view of inside of a vehicle mounted with a monitor and a key operator that are applicable to the vehicle surveillance system according to the first embodiment of the present invention;

FIG. 3 is a schematic view of a memory and a controller that are applicable to the vehicle surrounding image recorder according to the first embodiment of the present invention;

FIG. 4 is a magnified view of the key operator according to the first embodiment of the present invention;

FIG. 5 is a plane view of a vehicle mounted with digital cameras inside and outside of the vehicle according to the first embodiment of the present invention;

FIG. 6 is a side view of a vehicle mounted with digital cameras inside and outside of the vehicle according to the first embodiment of the present invention;

FIG. 7 is a schematic view of a monitor according to the first embodiment of the present invention;

FIG. 8 is a block diagram showing a constitution of the vehicle surveillance system according to the first embodiment and including a sound analyzer according to a second embodiment of the present invention; and

FIG. 9 is a block diagram showing a constitution of the vehicle surveillance system according to the first embodiment and including other peripheral devices (i.e., CD, DVD and TV Receiver) according to third embodiment of the present invention.

### DETAILED DESCRIPTION OF THE PREFERRED EMBODIMENT

Preferred embodiments of the present invention will now be described with reference to the accompanying drawings. In the following description, same drawing reference numerals are used for the same elements even in different drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

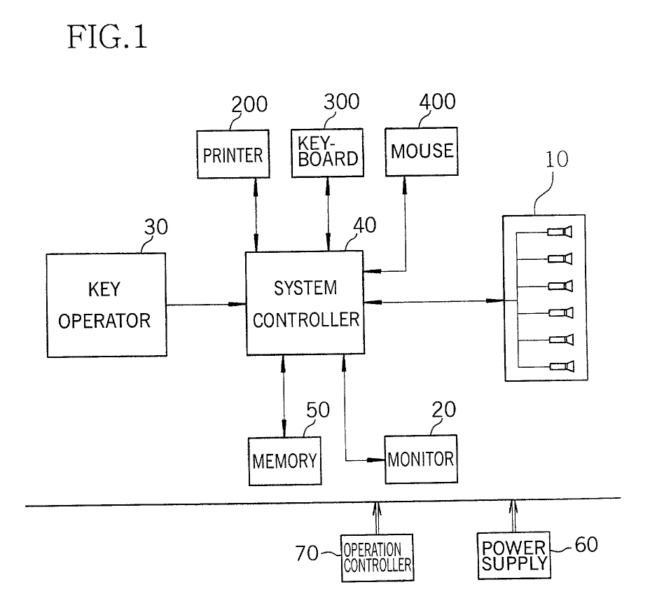

As depicted in FIGS. 1 through 7, a vehicle surveillance system according to the present invention includes a designated number of digital cameras 10 mounted on interior and exterior portions of the vehicle for photographing driving information of the vehicle (i.e., a dashboard), the indoor environment of the vehicle and outside views in various directions of the vehicle.

A monitor 20 is mounted on a front panel of the vehicle for displaying image information photographed by each digital camera 10 by splitting or magnifying the image information. A key operator 30 is integrated into the monitor 20 for user control in controlling the splitting of and inverting of the image information displayed through the monitor 20, and for setting a schedule of photographing for the digital cameras 10. A system controller 40 controls every part of the surveillance system according to an signal input via the key operator 30.

A memory 50 is attachable/detachable with the system controller 40 through a communication port (COM), and sequentially saves the image information photographed by the digital cameras 10 under the control of the system controller 40. The memory 50 has enough capacity to save the image information photographed for about 14 days, given that the digital cameras 10 can photograph 12 hours a day. This means that if one can install three memories 50, image information as long as 45 days can be saved.

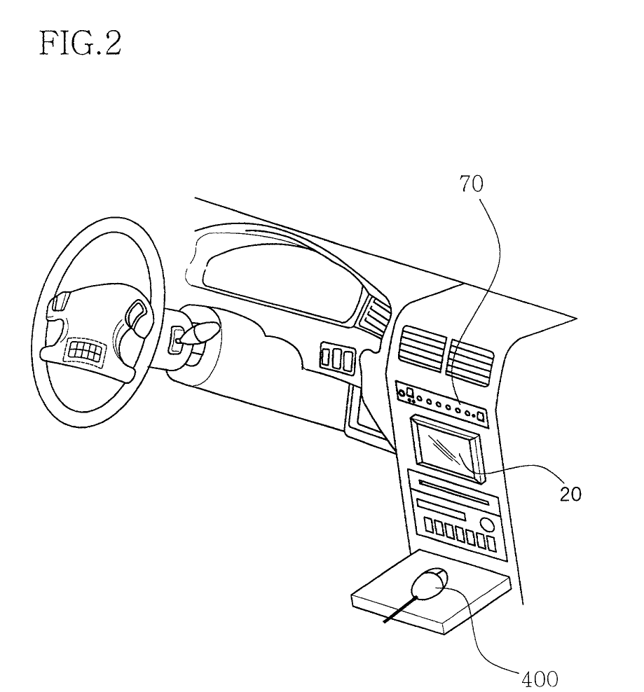

On the other hand, to save the image information from the memory 50 in a separate diskette, the system controller 40 has a special port just like one in a computer for the diskette to be inserted, and a communication port that connects a printer 200, a keyboard 300, and a mouse 400 together. Moreover, the system controller 40 can immediately output the image information saved in the memory 50 through the printer connected to the communication port. Also, as shown in FIG. 2, the mouse 400 is disposed at the front panel of the vehicle and is connected to the system controller 40 and the communication port for controlling the screen through the monitor 20.

Preferably, a hard disk can be used for the memory 50 to allow the data move freely.

A power supply 60 is provided and is kept charged by the vehicles battery. The power supply 60 supplies power to every part of the vehicle surveillance system; and an operation controller 70 is provided for turning on/off the power supply 60 and the rest of the above mentioned parts of the system.

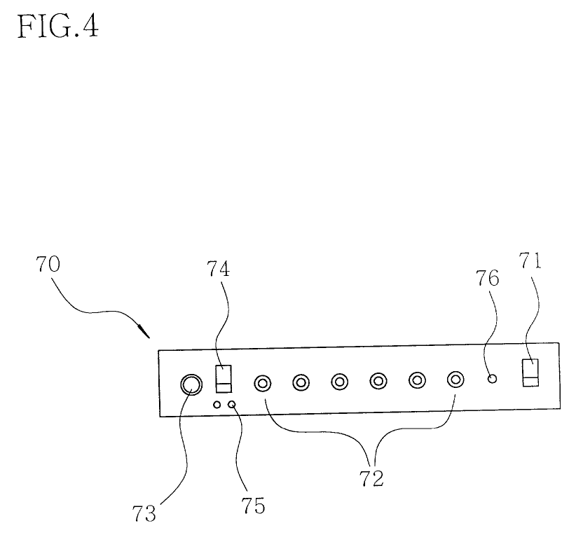

As shown in FIG. 4, the operation controller 70 includes a charging switch 71 for charging the power supply 60 through the car battery; a camera operation switch 72 for turning on/off the operation of each digital camera 10; a control switch 73 for controlling the operation of the system controller 40; a power supply switch 74 for supplying power provided by the power supply 60 to each part of the system; an LED (light emitting diode or device) 75 for indicating an operating status of the system controller 40; and a reset switch 76 for initializing the operating status of the system controller 40.

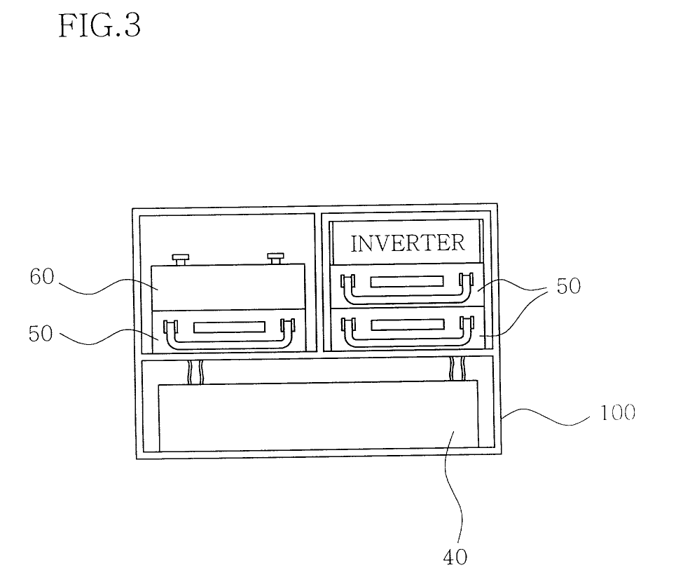

The system controller 40, the memory 50, and the power supply 60 are stored in a case 100, as shown in FIG. 3. Preferably, the case 100 is installed inside of the trunk of the vehicle.

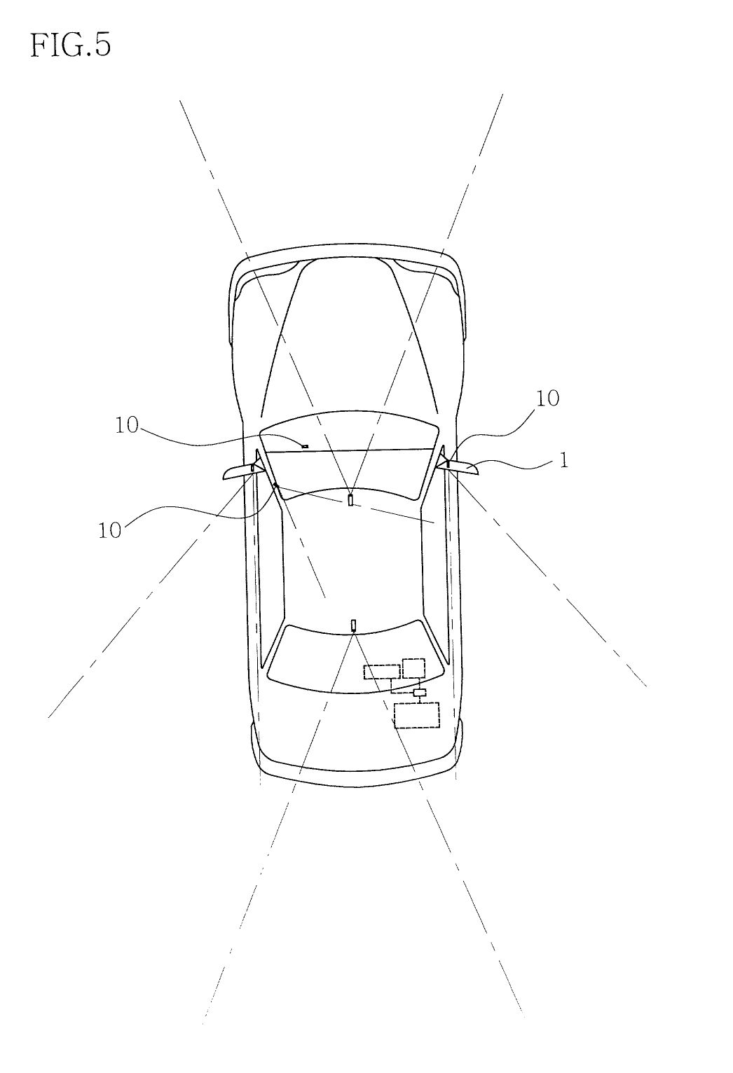

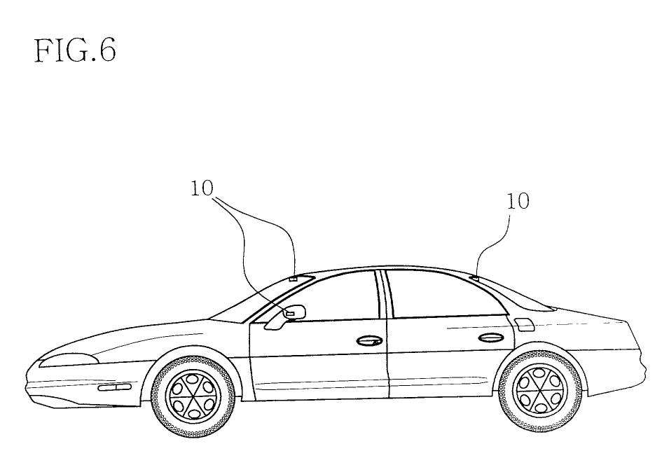

Referring now to FIGS. 5 and 6, the digital cameras 10 are mounted on the side mirrors 1 of the vehicle for photographing the areas to the rear of the vehicle, and are mounted on the front and the rear ceiling (roof) of the vehicle for photographing the forward and rearward outside views of the vehicle. Further, the digital cameras 10 are mounted inside the vehicle at a designated angles for photographing the dashboard and indoor environment. In total, 6 digital cameras are necessary to do the photographing, and sometimes, more than 6 digital cameras can be installed as well. For example, their can be four ceiling mounted cameras having a diagonal view point across the front and rear of the vehicle to cover more of the vehicles surrounding area than shown in FIG. 5.

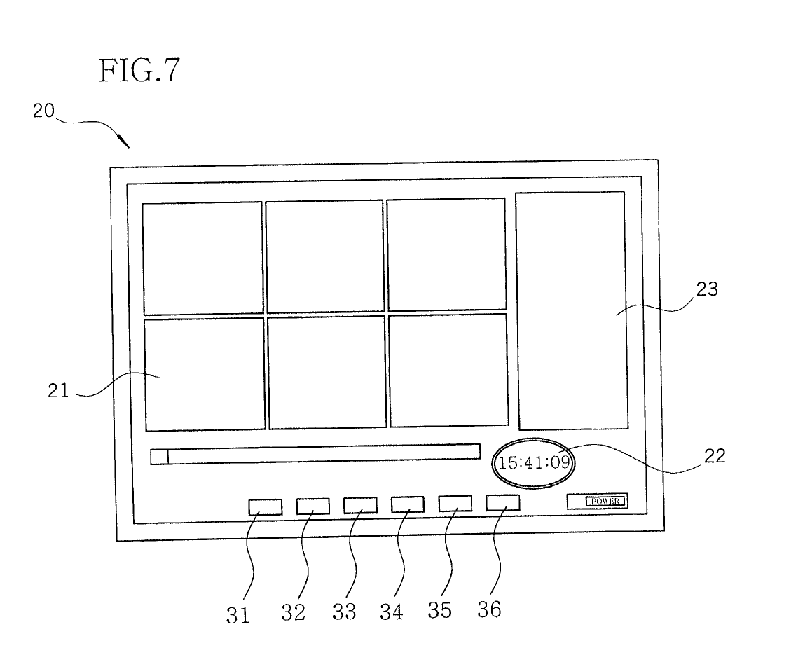

In the meantime, as shown in FIG. 7, the monitor 20 includes one or more screens 21 for displaying the images photographed by the digital cameras 10; a time display window 22 for displaying date and time of the photographing; and an information display window 23 for displaying the information on the image photographs of each digital camera 10 using the type of letters that a user can easily recognize.

Here, each screen 21 of the monitor 20 can have an additional function of varying the size thereof based on a touch screen method.

The key operator 30 preferably includes a primary button 31, a secondary button 32, and a third button 33 for inverting, split-inverting, and splitting the images displayed by the screen 21, respectively; a motion tracer button 34 for tracing the motions of the images; a search button 35; and a setup button 36.

More specifically, the primary button 31 inverts the images, which have been photographed by each digital camera 10 and displayed by the screen 21, to pictures one at a time in consecutive order.

The secondary button 32 splits the images, which have been photographed by each digital camera 10 and displayed by the screen 21, into 4, and inverts the split images.

The third button 33 splits the screen 21 into several regions in the same manner that has been set up by the setup button 36.

The search button 35 searches or deletes the image information saved in the memory 50 having been photographed by each digital camera 10.

The setup button 36 sets channels for the screen 21 which displays the image information photographed by each digital camera 10, a display screen color of the screen 21, a photographing schedule for every digital camera 10, and a photographing speed of the digital cameras 10, respectively.

Additionally, the setup button 36 can set the recording speed of the images photographed by the digital cameras 10, and adjust blocks and sensitivities of the images designated through the motion tracer button 34.

Based on the constitution described above, the operation of the present invention is now further explained with reference to FIGS. 1 through 7.

First of all, using the setup button 36 mounted on the key operator 30 of the monitor 20 that is installed at the front panel of the vehicle, it is possible to set the channels of the digital cameras 10 both at the inside and at the outside of the vehicle, the display screen color of the screen 21, and the photographing schedule and the photographing speed for each digital camera 10, respectively.

And, when the driver (user) turns on the operation controller 70 disposed at the front panel of the vehicle, more particularly, the charging switch 71 included in the operation controller 71, the car battery at the time of starting the car successfully charges the memory 50, the system controller 40, and the power supply 60 under the protection, respectively, complying with the on-operation of the charging switch 71, which is enabled by the case 100 at the inside of the trunk.

Furthermore, when the driver turns on camera operation switches 72, control switch 73, and power supply switch 7 all included in the operation controller 70, each digital camera mounted on the outside and on the inside of the vehicle starts to photograph the outside views and the indoor environment of the vehicle under the command of each switch, 72, 73 and 74, and the photographed images are later stored in the memory 50.

That is to say, the system controller 40 in the trunk starts to operate after every switch 72, 73 and 74 is turned on.

Here, the system controller 40 controls each digital camera 10 according to the setup conditions of the setup button 36 included in the key operator 30, and photographs the indoor and outdoor environment of the vehicle. Then, the system controller 40 saves the photographed image information in memory 50 that is attachable/detachable to the case 100, and displays the image information photographed by the digital cameras 10 to the driver through the screen 21 of the monitor on the front panel of the vehicle.

As mentioned before, about 6 or more digital cameras 10 are mounted on the side mirrors 1 of the vehicle for photographing to the rear of the vehicle, and on the front and the rear ceiling (roof) of the vehicle for photographing the outside views of the vehicle, and on the ceiling of the inside of the vehicle at a designated angle for photographing the dashboard and indoor environment.

Therefore, the system controller 40 is very useful for the driver because it detects the outside and the inside situation of the vehicle through each digital camera 10 even when the car is being parked. In addition, the system controller 40 provides the sense of security to the driver while he/she is driving the car by showing the driver the blind spots of the rearview mirror and the side mirrors 1 of the car through the screen 21 of the monitor 20 positioned on the front panel of the car. Briefly, the system controller 40 helps the driver park more safely, and provides him with wider vision while driving.

In other words, supposing that such image recorders are mounted on every vehicle, the digital cameras 10 will photograph other vehicles, consequently preventing the cars from being damaged or stolen. Of course, the cars can be damaged or stolen nonetheless. If that happens, the digital cameras 10 will come in very handy to trace who or what possibly stole or damaged the car(s).

The memory 50, as described above, is attachable/detachable to the case 100. Thus the memory 50 can be connected to another computer through which one can see the image information saved in the memory. The system controller 40 includes the communication port for connecting the printer 200 to the keyboard 300. Through the printer 200, the image information saved in the memory 50 can be printed on paper.

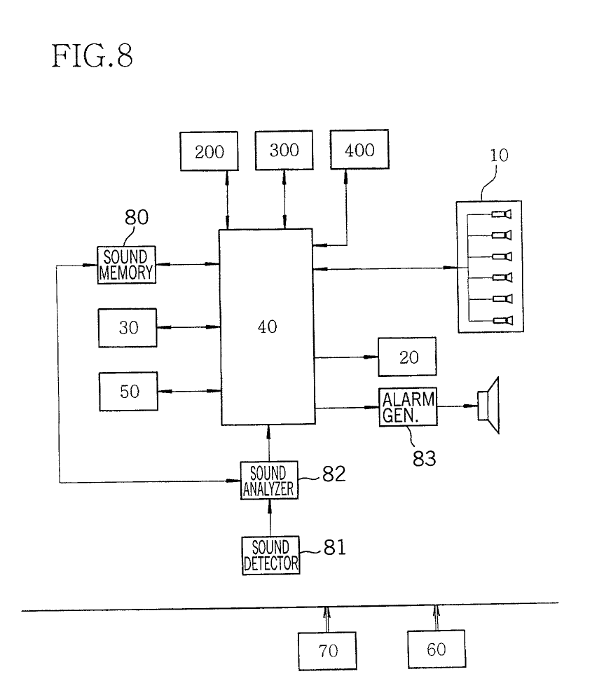

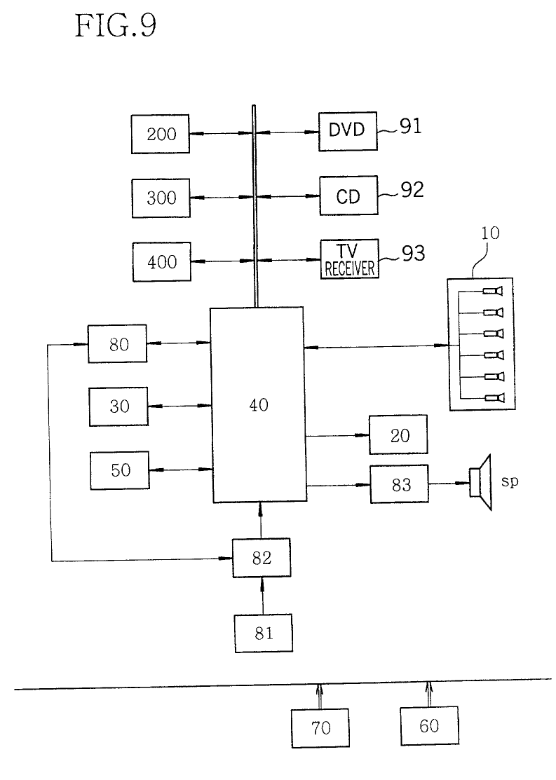

The vehicle surveillance system according to a second and third embodiments of the present invention, as shown in FIGS. 8 and 9, includes the same elements as described with respect to the first embodiment, and the details of those elements need not be explained further with respect to FIGS. 8 and 9.

Additionally, the vehicle surveillance system of the second and third embodiments include a sound memory 80 for saving sounds which may help prevent vehicle damage or vehicle theft. A sound detector 81 for detecting sounds, such as voices in the vicinity of the vehicle that has been parked, by a key operation of the key operator 30. A sound analyzer 82 for searching the sounds saved in the sound memory 80, when sounds are detected by the sound detector 81, for analyzing the sounds to determine whether there is a stored sound that corresponds to the detected sound, and for outputting warning information to the system controller 40. An alarm generator 83 outputs a designated level of alarm through a speaker to the outside of the vehicle under control of the system controller 40 based on the analysis from the sound analyzer 82.

Referring to FIG. 8, the operations of the sound analysis according to the second embodiment of the present invention are now explained as follows, the operations of the image recorder having been explained with respect to FIGS. 1-7.

The driver operates the key operator 30, while intending to park his vehicle for a long-term period, to enable the sound detector 81 to detects sounds around the parked vehicle and to transmit detected sound information to the sound analyzer 82.

Then the sound analyzer 82 searches the sound information saved in the sound memory 80 to analyze whether the saved sound information includes the sound information detected by the sound detector 81, and outputs the analysis to the system controller 40. For example, sound memory 80 can store such sounds as related to paint spray cans, metal tools being dropped to the pavement, etc., and voice information such as that which may be spoken by thieves or vandals.

At this time, based on the analysis from the sound analyzer 82, if the detected sound information collected from around the vehicle turns out to be harmful (i.e., relevant to a car theft or car damage), the system controller 40 controls the alarm generator 83.

The major function of the alarm generator 83 is to make a designated level of alarm through the speaker to the outside of the vehicle so that no harm or damage can be done on the vehicle.

On the other hand, in result of the analysis of the sound analyzer 82, if the sound information detected from around the vehicle is regarded as harmless, the alarm generator 83 is not operated accordingly.

The present invention, therefore, can prevent the car from being damaged or stolen using the detected sound information. Even if the alarm is sometimes neglected or disregarded, the image information including the photographing time and date by the digital cameras 10 is definitely very crucial to trace any evidence on the car theft or the car damage. Hence, the drivers do not have to be quite so insecure about parking their cars in the parking lot for long-term periods.

Here, to transfer the image information saved in the memory 50 to a separate diskette, the system controller 40 includes a port as in a computer, to which a diskette is inserted, and a communications port for connecting to printer 200, keyboard 300, and mouse 400.

Yet a third embodiment of the present invention provides peripheral devices that are connected to the vehicle surveillance system inside of the vehicle, as illustrated in FIG. 9.

Namely, the system controller 40 in FIG. 9 includes a digital moving image processor, and a digital video disk (DVD) port connected to a digital video disk player 91. In this way, the digital moving images can be seen through the monitor 20.

In addition, the system controller 40 includes a moving image processor of a compact disk (CD) and a CD port connected to a compact disk player 92, which enables the driver to see the CD moving images through the monitor 20.

Furthermore, the system controller 40 includes a video processor connected by a video port to a television receiver 93, through which general public broadcasting can be received and viewed on monitor 20, or a second monitor, in the car.

Although not shown in the figure, a wireless LAN card can be installed as well for a wireless transmission of the photographed image information to another location.

In conclusion, the present invention is very advantageous in that it enables the driver to see blind spots of the rearview mirror and the side mirrors and to check the inside of the vehicle and to prevent car damage or car theft, by mounting minicams both inside and outside of the vehicle to photograph the surroundings, and by installing an image recorder for saving and displaying the pictures or images photographed by the minicams, and mounting a sound detection system for analyzing the sound information relevant to the car damage or the car theft, and for outputting a designated alarm based on the detection result, especially when the warning sound information that might damage the vehicle is detected from the outside at a time when the driver parks the vehicle at the parking lot.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

What is claimed is:

1. A vehicle surveillance system, comprising:
a plurality of digital cameras mounted on a vehicles's interior and exterior for photographing a driving information, the interior environment of the vehicle and exterior views around the vehicle to eliminate blind spots inherent to the vehicle's mirrors;
a monitor mounted on a front panel of the vehicle for displaying image information photographed by each digital camera on a screen of said monitor;
a key operator integrated with the monitor and disposed on a front face of said monitor, said key operator being utilized by an occupant of said vehicle for controlling how the image information is displayed on the screen of said monitor and for setting a photographing schedule for the digital cameras;
a system controller for controlling every part of said vehicle surveillance system according to a signal input from said key operator;
a memory, being attachable/detachable with the system controller through a communications port, for sequentially saving the image information photographed by the digital cameras under the control of the system controller;
a power supply, being charged by a car battery, for supplying power to every part of the vehicle surveillance system; and
an operation controller for turning on/off the power supply and every part of the vehicle surveillance system.

2. The vehicle surveillance system as set forth in claim 1, wherein every part of the vehicle surveillance system is connected to said system controller through respective communications ports.

3. The vehicle surveillance system as set forth in claim 1, further comprising:
a printer, a keyboard and a mouse connected to said system controller through respective communications ports.

4. The vehicle surveillance system as set forth in claim 1, further comprising:
a case, mounted is a predetermined area of said vehicle, in which said power supply, said system controller and said memory are mounted.

5. The vehicle surveillance system as set forth in claim 1, further comprising:
a sound memory storing a plurality of predetermined sounds, including voice sounds;
a sound detector for detecting sounds in close proximity to said vehicle;
a sound analyzer for comparing a detected sound to the sounds stored in said sound memory; and
an alarm generator for generating an audible alarm through a speaker to the exterior of said vehicle when said sound analyzer determines the detected sound corresponds to one of said stored sounds.

6. The vehicle surveillance system as set forth in claim 1, further comprising:
a compact disc player, a digital video disk player and a television receiver each being connected to said system controller for displaying images on the screen of said monitor.

7. The vehicle surveillance system as set forth in claim 5, further comprising:
a compact disc player, a digital video disk player and a television receiver each being connected to said system controller for displaying images on the screen of said monitor.

8. The vehicle surveillance system as set forth in claim 1, said system controller including:
a charging switch for charging the power supply through the car battery;
a camera operation switch for turning on/off the operation of each digital camera;
a control switch for controlling the operation of the system controller;
a power supply switch for supplying power provided by the power supply to each part of the vehicle surveillance system;
a light emitting diode for indicating an operating status of the system controller; and
a reset switch for initializing the operating status of the system controller.

9. The vehicle surveillance system as set forth in claim 1, said monitor including:
a plurality of screens for displaying the images photographed by the digital cameras;
a time display window for displaying date and time of the photographing; and
an information display window for displaying information pertaining to the image photographs of each digital camera using user recognizable letters.

10. The vehicle surveillance system as set forth in claim 9, wherein an image displayed on any one of said screens can be magnified based on a touch screen method.

11. The vehicle surveillance system as set forth in claim 9, said key operator including:
a primary button for inverting the images, which have been photographed by each digital camera and displayed;
a secondary button for splitting and inverting the images, which have been photographed by each digital camera and displayed, and
a third button splitting the images, which have been photographed by each digital camera and displayed, into several regions;
a motion tracer button for tracing the motions of the images;
a search button for searching for the image information saved in the memory; and
a setup button for enabling the operator to control the functions of each of the named buttons include in said key operator.

12. The vehicle surveillance system as set forth in claim 9, said setup button being utilized to set channels for the screens to display the image information photographed by each digital camera, to set a display screen color, to set a photographing schedule for every digital camera, to set a photographing speed of the digital cameras, to set a memory recording speed for recording the images photographed by the digital cameras, and to adjust blocks and sensitivities of the images designated through the motion tracer button.

13. The vehicle surveillance system as set forth in claim 1, further comprising left and right side mirrors on which two of said digital cameras are mounted, said two digital cameras having a view point towards the rear of said vehicle.

14. The vehicle surveillance system as set forth in claim 1, further comprising
at least one of said digital cameras being mounted on an interior portion of the vehicles's roof for photographing areas in front of said vehicle;
at least one of said digital cameras being mounted on the interior portion of the vehicles's roof for photographing areas in back of said vehicle;
at least one of said digital cameras being mounted on an interior portion of the vehicles's roof for photographing a dashboard of said vehicle to photograph said driving information; and
at least one of said digital cameras being mounted on an interior portion of the vehicles's roof for photographing interior areas of said vehicle to photograph said interior environment.

15. A vehicle surveillance system comprising:
a sound memory storing a plurality of predetermined sounds, including voice sounds;
a sound detector for detecting sounds in close proximity to said vehicle;
a sound analyzer for comparing a detected sound to the sounds stored in said sound memory; and
an alarm generator for generating an audible alarm through a speaker to the exterior of said vehicle when said sound analyzer determines the detected sound corresponds to one of said stored sounds.

16. The vehicle surveillance system as set forth in claim 15, further comprising:
a plurality of digital cameras mounted on a vehicles's interior and exterior for photographing a driving information, the interior environment of the vehicle and exterior views around the vehicle to eliminate blind spots inherent to the vehicle's mirrors;
a monitor mounted on a front panel of the vehicle for displaying image information photographed by each digital camera on a screen of said monitor;
a key operator integrated with the monitor and disposed on a front face of said monitor, said key operator being utilized by an occupant of said vehicle for controlling how the image information is displayed on the screen of said monitor and for setting a photographing schedule for the digital cameras;
a system controller for controlling every part of said vehicle surveillance system;
an image memory, being attachable/detachable with the system controller through a communications port, for sequentially saving the image information photographed by the digital cameras under the control of the system controller;
a power supply, being charged by a car battery, for supplying power to every part of the vehicle surveillance system; and
an operation controller for turning on/off the power supply and every part of the vehicle surveillance system.

17. The vehicle surveillance system as set forth in claim 16, further comprising:
a compact disc player, a digital video disk player and a television receiver each being connected to said system controller for displaying images on the screen of said monitor.

18. The vehicle surveillance system as set forth in claim 16, further comprising:
a printer, a keyboard and a mouse connected to said system controller through respective communications ports.
